(19) United States
(12) Patent Application Publication
(10) Pub. No.: US 2006/0172411 A1
(43) Pub. Date: Aug. 3, 2006

(54) Composter

(76) Inventors: Clifford Roy Gamlin, TIVERTON (GB); Herbert Thomas Gamlin, Tiverton (GB)

Correspondence Address: NIELDS & LEMACK, 176 EAST MAIN STREET, SUITE 7, WESTBORO, MA, 01581, US

(21) Appl. No.: 10/545,139

(22) PCT Filed: Jan. 13, 2004
(86) PCT No.: PCT/GB04/00095

§ 371 Date: Nov. 9, 2005

(30) Foreign Application Priority Data
Jan. 13, 2003 (GB) 0300567.5

(51) Int. Cl. C05F 17/02; B01F 9/00

(52) U.S. Cl. 435/290.3; 366/228

(57) ABSTRACT

The composter provided by the invention is intended primarily for composting household waste, i.e. organic waste such as food waste and the like. To this end the composter comprises a rotatable drum with an inlet at an upstream end thereof and an outlet at a downstream end thereof, whereby, when the composter is in use, household waste placed in the composter at the inlet is caused to progress in stages from the upstream end thereof towards the downstream end thereof whereat the composted household waste may be removed at the outlet. The rotatable drum is of plygonal cross section, i.e. the drum is ten sided in order to facilitate periodic rotation of the drum between successive ones of its ten sides over a period of time. The inlet is mounted on the upstream end of the drum for orientation into an upright position after each rotational movement of the drum. Internally, the drum is provided with a series of deflector means for ensuring that the waste material is directed downstream away from the inlet and towards the outlet as the drum is rotated. The composter, which is moulded from plastic material, is provided with a receptacle for the recovery of leachate. Alternative uses of the composter includes the propagation of earth worms for fishermen.

This invention is concerned with improvements in a composter for domestic organic waste.

The disposal of household waste is becoming a major problem for householders, small enterprises and local authorities. This situation is not helped by the scarcity of appropriate landfill sites and the periodic increases in landfill charges together with the taxes accruing thereto.

Over recent years; however, there have been concerted efforts by many local authorities to reduce the demand for more landfill sites by adopting recycling procedures for all domestic rubbish.

Thus, provisions are now in place for recycling some materials, viz. glass, plastic and paper but not organic materials such as food waste and the like.

Composters for domestic organic waste have been available for many years, however, those that are in common usage are primarily of a static nature where domestic waste is placed into the upper part of a container and compost is eventually removed from the bottom of the container.

In static composter for domestic use, it is often difficult to gain ready access to the composted material due to the natural fall of the material stacked over that, which is being removed.

In addition, no provision is made in the static types of composter for recovery and use of the leachate that is produced as a side product from composted organic waste.

In use, domestic composters are rather unsightly and are, therefore, to be found in out-of-the-way parts of an allotment or garden. Thus, in inclement weather conditions, it is often too inconvenient to venture out to place domestic waste of an inorganic nature in the composter.

There have also been very many proposals for use in the treatment of farmyard and other organic waste. Some proposals have included the use of rotary drums, often several metres in length, with complex apparatus for controlling the rotation of the drum, the input of the material to be treated and the input of the accelerants that may be used to speed the treatment process.

These industrial sized composters are sometimes provided with means for the recovery of leachates from the treated materials; but once again complex recovery means are required for effecting the recovery.

It is, therefore, one of the objects of the present invention to provide a more user friendly composter that makes provision for the ready removal of the composted material.

It is another of the objects of the present invention to provide a composter that makes provision for the ready removal the leachates produced as a by-product of the composting process.

It is a further object of the present invention to provide a composter which is appealing to the eye to an extent that its juxtaposition to a dwelling is not objectionable.

Thus, the present invention conveniently provides a composter for domestic organic waste, the composter comprising a rotatable drum having an upstream end wall and a downstream end wall, a peripheral wall of the drum providing support on an inner surface thereof for conventional deflector means for directing organic waste material from an upstream end of the rotatable drum towards a downstream end thereof when the drum is in use, characterised in that the upstream end wall provides support for inlet means, whereby, when the composter is in use and the rotatable drum thereof is rotated in a first direction, the inlet means is rotated in an opposite direction to thereby maintain the inlet means in an upright orientation for receiving waste material to be composted.

Preferably, the inlet means comprises a box-like chute provided on a rear wall portion with a cylindrical coupling means adapted to be located, in use, in a circular opening provided in the upstream end wall of the drum to support the inlet means as aforesaid.

In one convenient arrangement provided by the present invention the coupling means may comprise an annular flange located, in use, inside the rotatable drum and against an inside surface of the upstream end wall of the drum to retain the box-like chute therein.

In another convenient arrangement provided by the present invention the drum may provide support, at its downstream end thereof, for a receptacle for composted organic material, the receptacle, which is of box shaped configuration, is received, in use, in a complementary shaped opening defined by an appropriately configured portion of the downstream end wall of the drum, the arrangement being such that, when the composter is in use, the receptacle lies in a normal upright condition when the rotatable drum is in a starting position, the receptacle being rotated through 360 degrees with the drum until it is once again in it's normal upright condition thereby enabling the removal of the receptacle and it's composted contents.

Preferably, the drum comprises a lower trough-like portion and an upper inverted trough-like portion wherein the upstream end wall may be provided by aligned planar portions of each trough-like portion.

In a further preferred arrangement, the circular opening providing the support for the inlet means is comprised of a semi-circle recess in each of the aligned planar portions of each upstream end wall.

Conveniently, an axis of the circular opening in the upstream end wall is arranged to be coincident, or substantially so, with the longitudinal axis of the rotatable drum.

Preferably, the rotatable drum is in the form of a polygon in cross-section and may be ten sided with each of the sides of the polygon are of equal width.

Preferably, the rotatable drum, the inlet means and the receptacle may be made from plastics materials.

In a further preferred arrangement provided by the present invention, the rotatable drum may be provided with perforations to facilitate the drainage of leachate and the rotatable drum may conveniently be supported on a plastics drainage tank for the leachate.

In one more preferred arrangement, provided by the present invention, the composter may be configured to look like an animal, i.e. a farmyard animal or a wild animal.

There now follows, by way of example of the invention, a detailed description of a novel composter, which description is to be read with reference to the accompanying drawings in which;

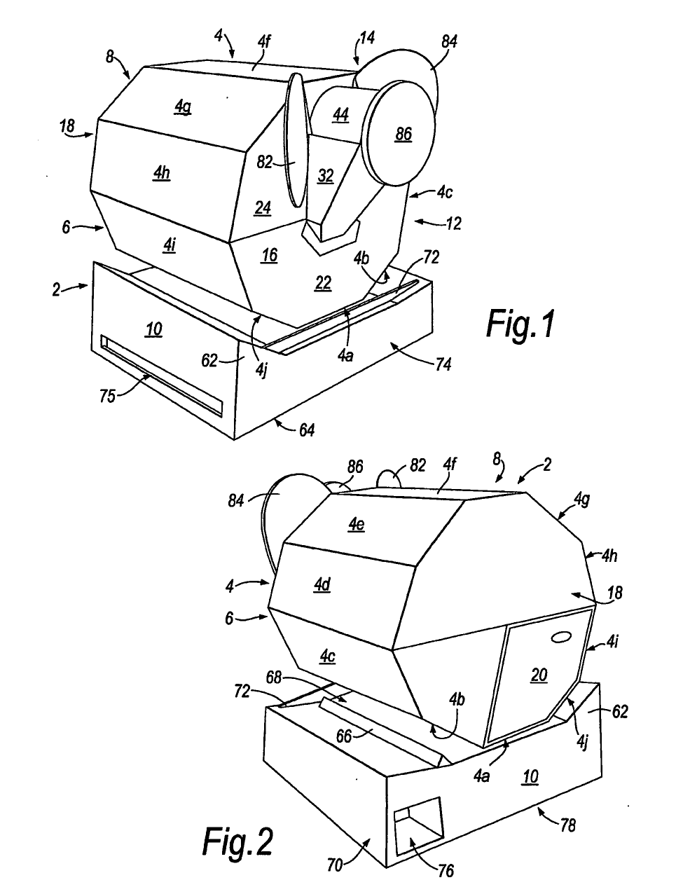

FIG. 1 is a front perspective view of a composter;

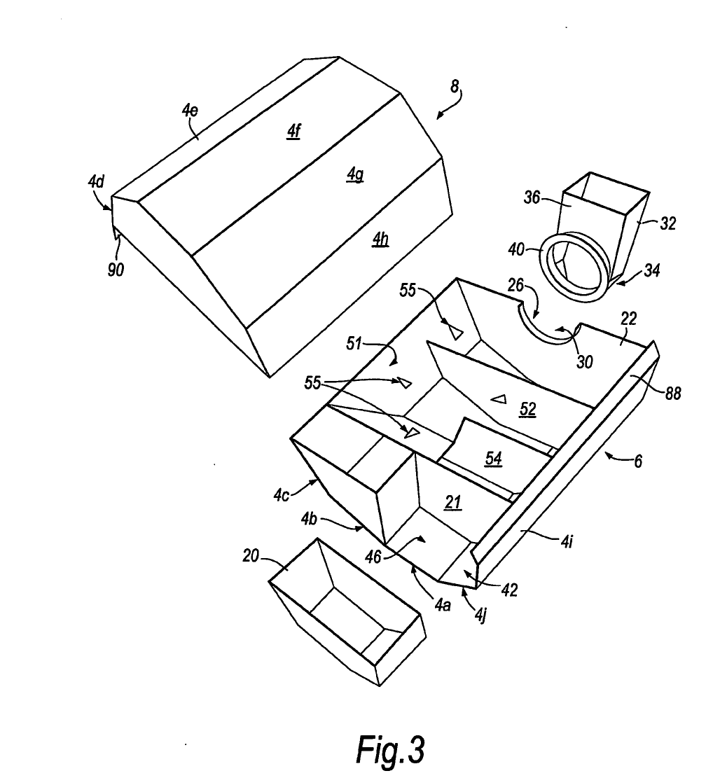

FIG. 2 is a rear perspective view of the composter shown in FIG. 1;

FIG. 3 is an exploded perspective view of part of the composter shown in FIGS. 1 and 2;

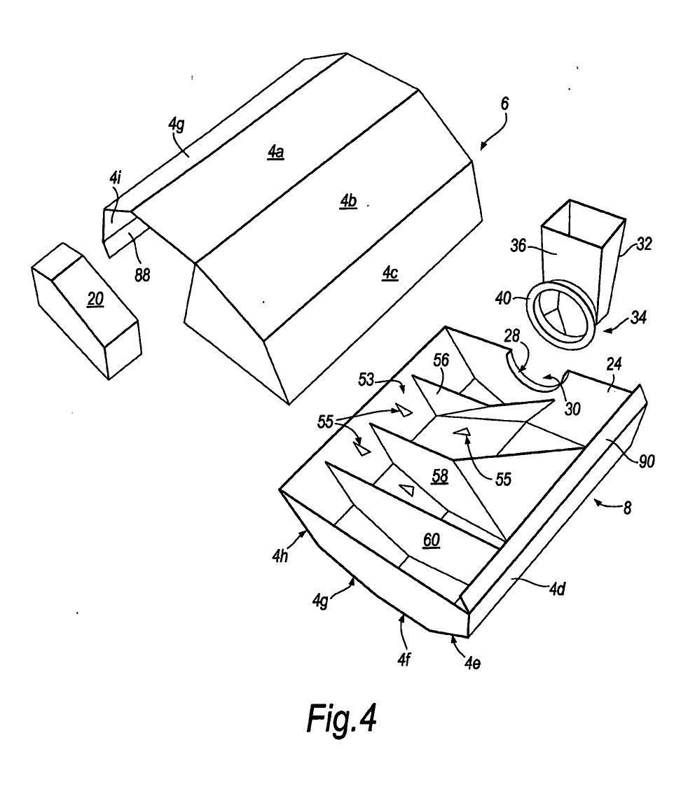

FIG. 4 is an exploded inverted view of the composter part shown in FIG. 3;

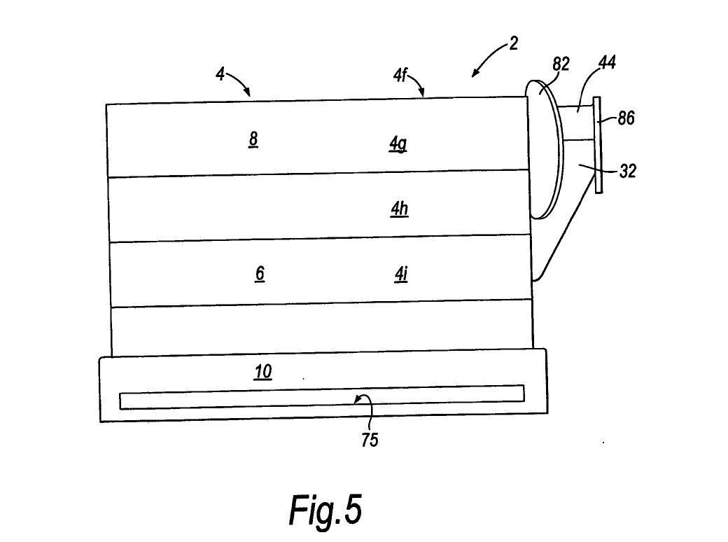

FIG. 5 is a side view of the composter shown in FIG. 1 as seen in the direction of the arrow V in that Figure; and,

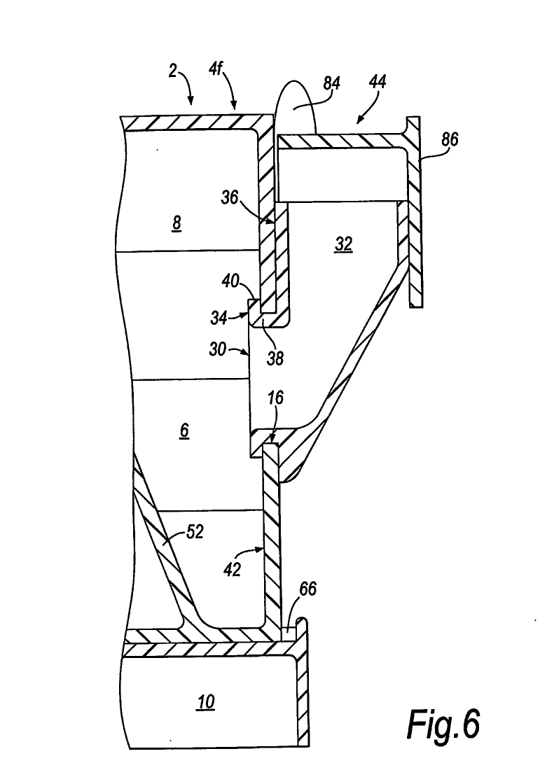

FIG. 6 is a part section view taken along the line VI-VI of FIG. 1.

The present invention provides a user friendly, aesthetically pleasing composter 2, which is configured to have a shape approximating to that of a pig, see FIGS. 1 and 5.

The composter 2 is in the form of a rotatable drum 4 comprised of a lower trough-shaped portion 6 and an upper, inverted, trough-shaped portion 8, see FIGS. 3 and 4, the rotatable drum 4 being mounted on a drainage tank 10 for a purpose to be described hereinafter.

The rotatable drum 4 comprises an upstream end 12, where an inlet means 14 is supported on an upstream end wall 16, see FIGS. 1 and 6.

The drum 4 also comprises a downstream end 18, where a receptacle 20 is positioned in a configured downstream end wall 21 of the drum 4 for a purpose to be described hereinafter, see FIGS. 3 and 4.

The end wall 16, of the drum 4, is formed by co-planar wall portions 22 and 24 of the lower and upper trough-shaped portions 6 and 8 respectively.

The co-planar wall portions 22 and 24 are formed with a semi-circular cut out portions 26 and 28 respectively, which cut out portions form a circular hole 30 in said end wall 16, see FIGS. 3, 4 and 6.

The inlet means 14 comprises a box-like chute 32 having a flanged coupling 34 provided on a rear wall 36 thereof, see FIGS. 3, 4 and 6, a reduced diameter portion 38 of the flanged coupling 34 being received in the circular hole 30 when the lower and upper trough-shaped portions 6 and 8 are conjoined to form the rotatable drum 4.

From FIG. 6 it will be apparent that a flanged portion 40 of the coupling 34 is located against an inside surface 42 of the wall 16 to thus retain the inlet means on the wall 16 of the rotatable drum 4.

The inlet means 14 has a closure cap 44, which is shown in section, in FIG. 6, as a simple attachment; however, in an alternative arrangement the closure cap 44 may be hingedly mounted on the rear wall 36 of the chute 32.

The receptacle 20, which is received in a complementary shaped opening 46 provided by the configured dowmsteam end wall 21, see FIG. 3 is of box-like structure and is readily placed in and removed from the opening 46.

The rotatable drum 4 is formed as a regular polygon in cross-section having ten sides 4a, 4b, 4c, 4d, 4e, 4f, 4g, 4h, 4i and 4j, see FIGS. 2, 3 and 4, which sides are of equal width and are each provided with perforations, not shown, for a purpose to be described hereinafter.

The lower trough-shaped portion 6 of the drum 4 is provided with conventional deflector blades 50 and 52, see FIG. 3, while the upper trough-shaped portion 8 is provided with conventional deflector blades 56, 58 and 60, see FIG. 4.

The deflector blades in the trough-shaped portions 6 and 8 are arranged in spaced relationship to define sections of reduced volume from the upstream end to the downsream end of the rotatable drum 4.

The deflector blades also extend to the full depth, or approximately so, of their respective trough-shaped portions, whereby a closed, continuous path is formed between the upstream and downstream ends of the rotatable drum 4.

In addition, the deflector blades 50 to 60 and inner surfaces 51 and 53 of the trough-shaped portions 6 and 8 respectively, are provided with spike elements 55, only a few of which are shown in FIGS. 3 and 4 and the purpose of which will be described hereinafter.

The lower trough-shaped portion 6 is formed with an elongate extension wall 88 adapted, in use, to engage with the side 4h of the upper trough-shaped portion 8. Likewise, the upper trough-shaped portion 8 is formed with an elongate extension wall 90 adapted, in use, to engage with the side 4c of the lower trough-shaped portion 6.

The portions 6 and 8 may be secured together by any suitable means, for example they may simply be glued together or they may be secured one to the other by tie bolts.

The drainage tank 10, which is of simple inverted box-like construction, is provided with an angled retaining wall portion 62, at a left-hand side 64 thereof, see FIG. 1.

The drainage tank 10 is also provided with a retaining ridge 66, formed on an upper surface 68 and towards an opposite side edge 70 thereof, see FIGS. 2 and 6.

In addition the drainage tank 10 is provided with a retaining ridge 72, formed on the upper surface 68 and towards a front end 74 thereof, see FIGS. 1, 2 and 6.

The drainage tank 10 is further provided with an aperture 76 in a rear wall 78 thereof for accommodating a receptacle, not shown, for a purpose to be described hereinafter.

In addition, the drainage tank is provided with an elongate aperture 75 formed in the side 70 thereof for a purpose to be described.

The upper surface 68 of the drainage tank 10 is raked downwards at a small angle towards the front end 74 thereof. Drainage holes, not shown, are provided through the upper surface of the tank 10 adjacent the ridge 72, which holes overlie a drainage channel, not shown, for a to be described hereinafter.

The upstream end wall 16 of the rotatable drum 4 is provided with two appendages 82 and 84, while the closure cap 44 is provided with a disc-shaped front wall 86, see FIGS. 1, 2 and 6.

These appendages 82 and 84, together with the front wall 86 of the closure cap 44, give the composter a configuration approximating to that of a pig thereby enhancing the aesthetic appeal of the composter 4.

Instead of the appendages 82, 84 and 86, it will be appreciated that other embellishments may be used to give the rotatable drum 4 the general configuration of any farmyard or wild animal.

In use, with the composter 4 in the position shown in FIG. 1 with the side 4a of the drum lowermost, a batch of organic waste, that is potato peelings and other vegetable waste, is placed into the chute 32 along with any required accelerants for speeding the process of composting of the batch.

When a next batch is to be placed in the composter 4, the user places a toe in the aperture 75 to gain a foothold and then rotates the drum 4 in a clockwise direction, as viewed from the upstream end 12 thereof. The rotation of the drum 4 brings the side 4b of the drum 4 into the lowermost position, the inlet means 14 is then rotated anti-clockwise into it's upright position. The next batch of waste material is then placed in the chute 32 together with any required accelerant.

Periodically, over a ten to thirty weeks, the process is repeated until the side 4a of the drum 4 is once again in the lowermost position. Composted material may then be removed from the composter because the last rotation of the rotatable drum 4 will have caused composted material to be deposited in the receptacle 20, the operative simply has to remove the receptacle to recover the same.

In its passage through the composter, the waste material is constrained by the deflector blades to separate sectors of the composter 2 thereby ensuring that the composting process is not prejudiced by cross contamination between part composted materials in adjacent sectors.

In addition, the spike elements 55 engage with the part composted material to cause air to be entrained therein each time the rotatable drum 4 is moved clockwise to it's next position and the part composted material is moved along the path defined by the deflector blades 50 to 60; this aeration of the waste material assists in the composting process.

The structure of the composter 2 ensures that the contents thereof are not accessible to vermin, birds and household pets.

Also, because the sides 4a to 4j of the rotatable drum 4 are perforated at each sector thereof, any leachate will run clear of the material in each sector thereby avoiding any slowing down of the composting process. In addition any malodorous side-affects are negated by ensuring that the part composted waste material does not contain too much moisture.

The leachate that has drained from the rotatable drum 4 runs along the raked upper surface 68 to the drainage holes therein, the leachate then flowing along the drainage channels, not shown, to be deposited in a receptacle located in the aperture 76.

The recovered leachate may be used in the garden, perhaps as fertiliser for a lawn.

The accelerant used in the composing process may be any recommended bacterial inoculant.

It will be readily appreciated that the retaining wall portion 62 together with the ridges 66 and 72 assist in retaining the rotatable drum 4 on the drainage tank 10 as it is being rotated in use.

All of the components of the composter 2 are made from glass reinforced plastic; however, the components may be made from suitable plastic materials by injection moulding and/or blow moulding and/or rotational moulding processes.

From the above description of the present invention, it will be readily appreciated that the polygon shaped rotatable drum may be formed with a plurality of sides commensurate with dealing with the amount of organic waste to be treated and the regularity with which the rotatable drum 4 has to be indexed between the placing of the fresh untreated organic waste material.

In order to accelerate the digestion of the waste organic material, worms, e.g. specially-bred tiger worms may usefully be employed; however, the number of worms used may have to be bolstered periodically for the best results.

The “composter” arrangement of the present invention may be adapted for another use, i.e. the propagation of earth worms for fishing purposes.

In addition the “composter” arrangement may be used as a means for “keeping” surplus worms in high-welfare conditions between fishing expeditions.

In such case, the “composter” arrangement would not carry waste organic material; instead, a more user-friendly leaf-mould or finished compost would provide an acceptable habitat for the worms.

1. A composter for domestic organic waste, the composter comprising a rotatable drum having an upstream end wall and a downstream end wall, a peripheral wall of the drum providing support on an inner surface thereof for conventional deflector means for directing organic waste material from an upstream end of the rotatable drum towards a downstream end thereof when the drum is in use, characterised in that the upstream end wall provides support for inlet means, whereby, when the composter is in use and the rotatable drum thereof is rotated in a first direction, the inlet means is rotated in an opposite direction to thereby maintain the inlet means in an upright orientation for receiving waste material to be composted.

2. A composter according to claim 1, characterised in that the inlet means comprises a box-like chute provided on a rear wall portion with a cylindrical coupling means adapted to be located, in use, in a circular opening provided in the upstream end wall of the drum to support the inlet means as aforesaid.

3. A composter according to claim 2, characterised in that the coupling means comprises an annular flange located, in use, inside the rotatable drum and against an inside surface of the upstream end wall of the drum to retain the box-like chute therein.

4. A composter according to claim 1, characterised in that the drum provides support, at its downstream end thereof, for a receptacle for composted organic material, the receptacle, which is of box shaped configuration, is received, in use, in a complementary shaped opening defined by an appropriately configured portion of the downstream end wall of the drum, the arrangement being such that, when the composter is in use, the receptacle lies in a normal upright condition when the rotatable drum is in a starting position, the receptacle being rotated through 360 degrees with the drum until it is once again in it's normal upright condition thereby enabling the removal of the receptacle and it's composted contents.

5. A composter according to claim 1, characterised in that the drum comprises a lower trough-like portion and an upper inverted trough-like portion.

6. A composter according to claim 5, characterised in that the upstream end wall is provided by aligned planar portions of each trough-like portion.

7. A composter according to claim 5, characterised in that the circular opening providing the support for the inlet means is comprised of a half-circle in each of the aligned planar portions of each upstream end wall.

8. A composter according to claim 2, characterised in that an axis of the circular opening in the upstream end wall is arranged to be coincident, or substantially so, with the longitudinal axis of the rotatable drum.

9. A composter according to claim 1, characterised in that the rotatable drum is in the form of a polygon in cross-section.

10. A composter according to claim 9, characterised in that the rotatable drum is ten sided.

11. A composter according to claim 10, characterised in that each of the sides of the polygon are of equal width.

12. A composter according to claim 1, characterised in that the rotatable drum and the inlet means are made from plastics materials.

13. A composter according to claim 4, characterised in that the receptacle is moulded from plastic material.

14. A composter according to claim 1, characterised in that the rotatable drum is provided with perforations to facilitate the drainage of leachate.

15. A composter according to claim 1, characterised in that the rotatable drum is supported on a drainage tank for leachate.

16. A composter according to claim 15, characterised in that the drainage tank is moulded from a plastics material.

17. A composter according to claim 1, characterised in that the composter is configured to look like a farmyard animal or a wild animal.

18. (canceled)
